(19) United States
(12) Patent Application Publication
(10) Pub. No.: US 2025/0327462 A1
(43) Pub. Date: Oct. 23, 2025

(54) HOLOGRAPHIC PROJECTION COOLING FAN

(71) Applicant: Dynatron Corporation, Union, CA (US)

(72) Inventor: Po-Wei HUANG, Taipei (TW)

(21) Appl. No.: 18/640,168

(22) Filed: Apr. 19, 2024

(51) Int. Cl. F04D 25/08; G03H 1/00; G06F 1/20; H02J 50/00; H02J 50/10

(52) U.S. Cl. CPC F04D 25/08; G03H 1/0005; G06F 1/20; H02J 50/005; H02J 50/10; G03H 2001/0088

(57) ABSTRACT

A holographic projection cooling fan comprises a frame, a driving assembly disposed on the frame, a fan blade assembled with the driving assembly, a holographic display assembly fixed on the fan blade, and a power conducting assembly. The power conducting assembly comprises a power supply coil disposed on the frame, and a power receiving coil disposed on the fan blade and directly facing the power supply coil, wherein the power receiving coil is connected to the holographic display assembly, the power supply coil obtains power from a transmissible power source on the holographic cooling fan, and the power receiving coil coordinates with the power supply coil to supply the power to the holographic display assembly.

### FIELD OF THE INVENTION

The present invention provides a cooling fan, in particular to a cooling fan with a holographic display assembly.

### BACKGROUND OF THE INVENTION

CN110083007A and CN207609586U disclose a fan with holographic display, respectively, wherein an electromagnetic power supply structure is disposed thereof.

However, the solution disclosed by CN110083007A has greatly changed a common structure of the fan. CN207609586U has greatly changed a design of a driving assembly, which is not conducive to use and manufacture of existing holographic projection cooling fans.

### SUMMARY OF THE INVENTION

A main object of the invention is to solve problems existing in a conventional structure.

In order to achieve the above object, the present invention provides a holographic projection cooling fan which comprises a frame, a driving assembly disposed on the frame, a fan blade assembled with the driving assembly, a holographic display assembly fixed on the fan blade, and a power conducting assembly. The power conducting assembly comprises a power supply coil disposed on the frame, and a power receiving coil disposed on the fan blade and directly facing the power supply coil, wherein the power receiving coil is connected to the holographic display assembly, the power supply coil obtains power from a transmissible power source on the holographic cooling fan, and the power receiving coil coordinates with the power supply coil to supply the power for the holographic display assembly

In one embodiment, the frame comprises a channel, and a mounting seat located in the channel and provided for the driving assembly and the power supply coil to be mounted thereon, and the fan blade comprises a hub for setting the power receiving coil and a plurality of blades connected to the hub.

In one embodiment, the mounting seat is formed with an annular groove for setting the power supply coil.

In one embodiment, the hub comprises a base plate for fixing the holographic display assembly thereon and a plurality of annular walls formed at one side of the base plate at intervals; the power receiving coil is disposed between any two adjacent ones among the plurality of annular walls, the power receiving coil comprises two ends, and the base plate is formed with at least one through hole for the two ends passing through.

In one embodiment, the driving assembly comprises a circuit board and a motor connected to the circuit board, and the circuit board receives external power.

In one embodiment, the power supply coil is located at a periphery of the circuit board.

In one embodiment, the hub comprises an isolation ring assembled with an innermost ring of the plurality of annular walls and facing the driving assembly.

In one embodiment, the holographic display assembly comprises a lamp plate fixed on the fan blade and at least one cover plate disposed on the lamp plate.

In one embodiment, the cover plate and the lamp plate are both fixed on the fan blade.

In one embodiment, the holographic display assembly comprises a wireless communication module.

In addition to the above, the present invention further provides a holographic projection cooling fan comprising a frame, a driving assembly disposed on the frame, a fan blade assembled with the driving assembly, a holographic display assembly fixed on the fan blade, and a power conducting assembly. The frame is applied to an electronic device implemented with an ATX (Advanced Technology Extended) architecture. The power conducting assembly comprises a power supply coil disposed on the frame, and a power receiving coil disposed on the fan blade and directly facing the power supply coil, wherein the power supply coil obtains power from a transmissible power source on the holographic cooling fan to establish a magnetic field, and the power receiving coil rotates with the fan blade and is located in the magnetic field to induce electricity and supply the power to the holographic display assembly.

Compared with that prior art and according to the above embodiments, the present invention has the following characteristic: the power supply coil of the power conducting assembly of the present invention is disposed on the frame; and the power receiving coil is disposed on the fan blade and directly faces the power supply coil. The power receiving coil induces the magnetic field established by the power supply coil, so that the holographic display assembly can obtain the power to work. The holographic projection cooling fan in the present invention solves a power supply problem of the holographic display assembly without excessively changing the design of the driving assembly or a common structure of the cooling fan.

### BRIEF DESCRIPTION OF THE DRAWINGS

FIG. 1 is a schematic structural diagram of a holographic projection cooling fan of the present invention.

FIG. 2 is a schematic structural diagram of the profile of a holographic projection cooling fan of the present invention.

FIG. 3 is a first schematic decomposition diagram of a holographic projection cooling fan of the present invention.

FIG. 4 is a second schematic decomposition diagram of a holographic projection cooling fan of the present invention.

FIG. 5 is a schematic structural diagram of a fan blade of a holographic projection cooling fan of the present invention.

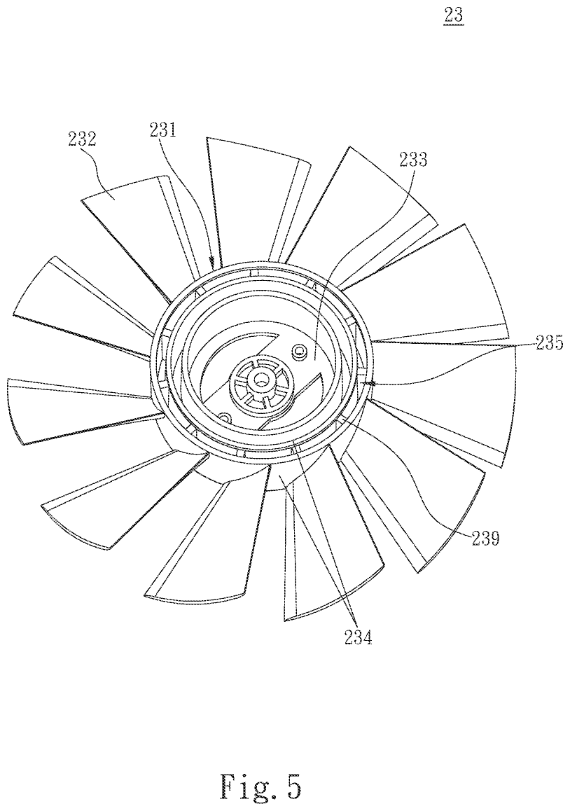

### DETAILED DESCRIPTION OF THE PREFERRED EMBODIMENTS

The detailed description and technical content of the invention are described below with reference to the accompanying drawings.

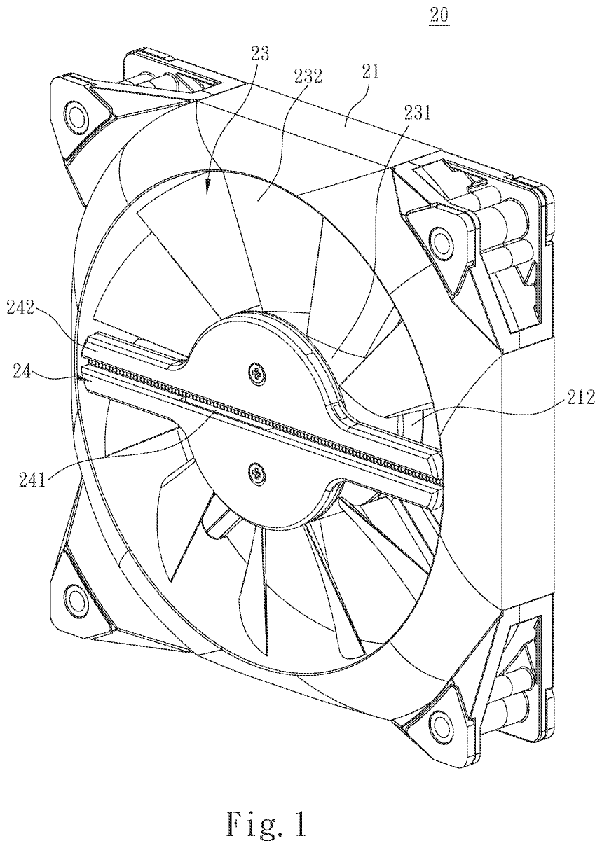

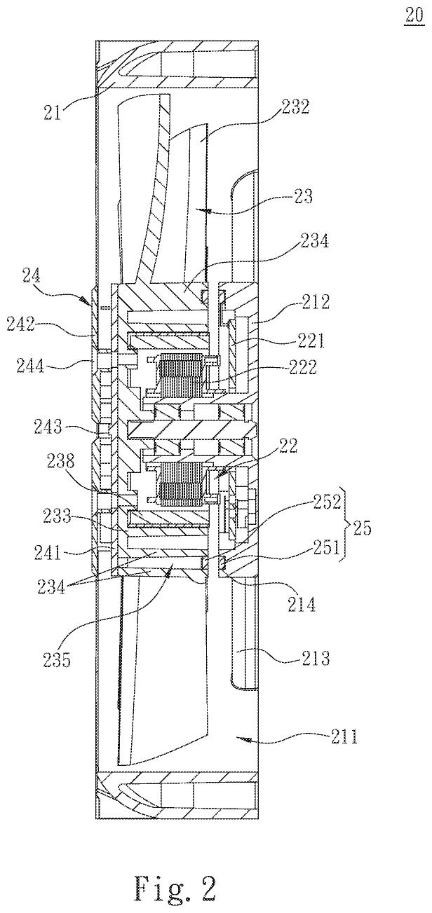

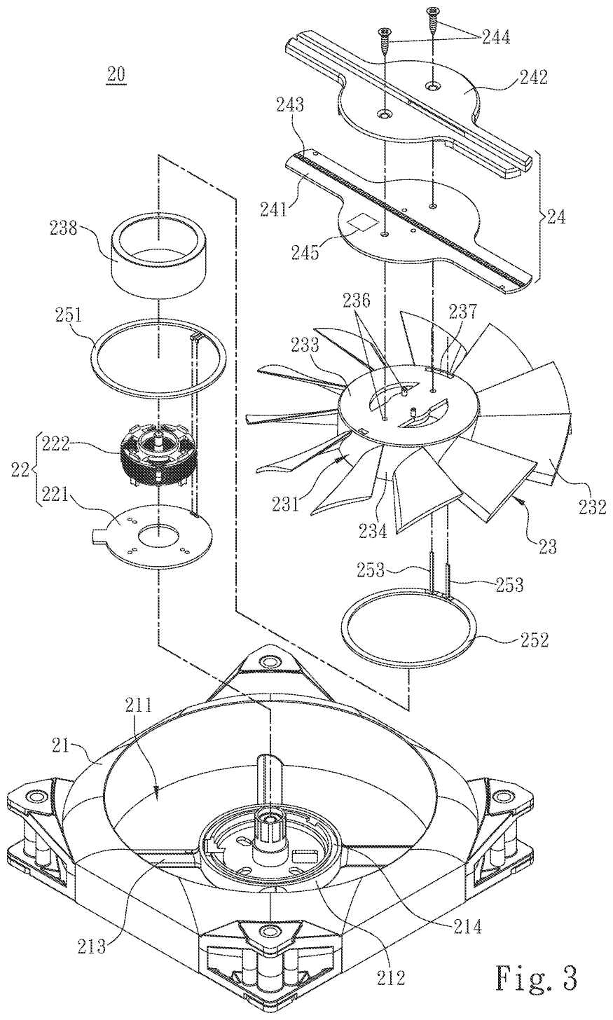

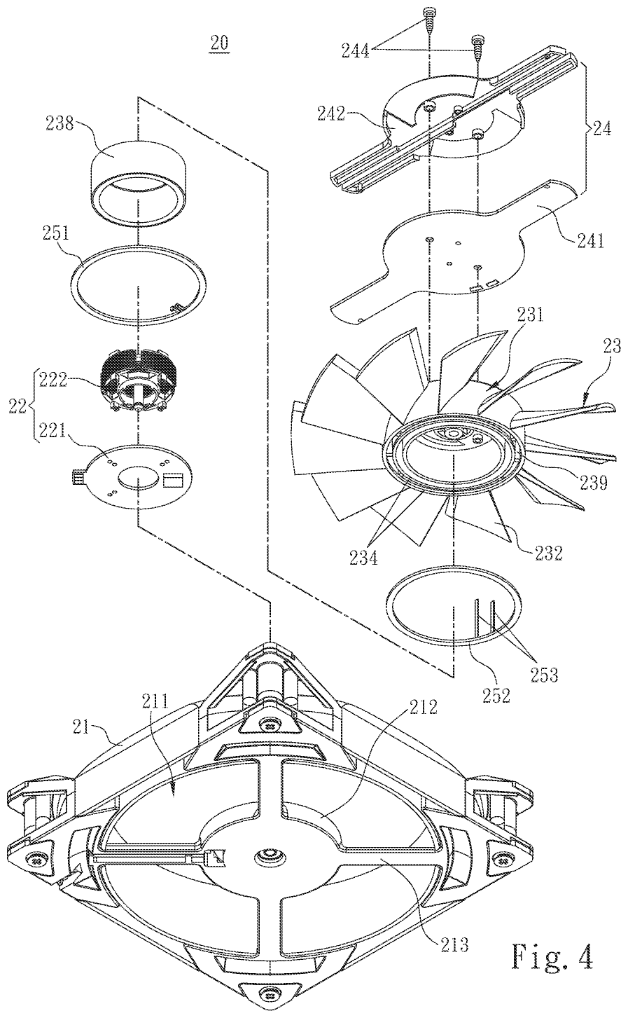

Referring to FIG. 1, FIG. 2, FIG. 3, and FIG. 4, the present invention provides a holographic projection cooling fan 20. The holographic projection cooling fan 20 can be configured on a computer case or an electronic device or can be assembled with an electronic component. A basic function of the holographic projection cooling fan 20 of the present invention is to generate airflow for a cooling operation. The holographic projection cooling fan 20 comprises a frame 21, a driving assembly 22, and a fan blade 23. The frame 21 is applied to an electronic device implemented with an ATX architecture. The driving assembly 22 is disposed on the frame 21. The driving assembly 22 can receive external power supply through a power transmission line or at least one conductive terminal, wherein the at least one conductive terminal is disposed on a periphery of the frame 21. When the driving assembly 22 is activated, the fan blade 23 is driven to rotate. The holographic projection cooling fan 20 of the present invention further comprises a holographic display assembly 24 and a power conducting assembly 25. The holographic display assembly 24 is fixed on the fan blade 23, that is, the holographic display assembly 24 rotates with the fan blade 23. The holographic display assembly 24 displays holographic images during the rotation. The power conducting assembly 25 comprises a power supply coil 251 and a power receiving coil 252. The power supply coil 251 and the power receiving coil 252 may be of a pancake coil structure respectively. The power supply coil 251 is disposed on the frame 21 and obtains power from a transmissible power source on the holographic projection cooling fan 20 to establish a magnetic field. Further, the transmissible power source can be the driving assembly 22, the power transmission line or the at least one conductive terminal. In the embodiment shown in FIG. 2 of the present invention, the power supply coil 251 is connected to the driving assembly 22 is taken as an example. On the other hand, the power receiving coil 252 is disposed on the fan blade 23 and rotates with the fan blade 23. The power receiving coil 252 is connected to the holographic display assembly 24 to be a power supply source for the holographic display assembly 24. The power receiving coil 252 directly faces the power supply coil 251. In one embodiment, the power supply coil 251 is located in a projection range of the power receiving coil 252, as shown in FIG. 2. The power receiving coil 252 is in a coordination relationship with the power supply coil 251. A position of the power receiving coil 252 is designed to be within the magnetic field established by the power supply coil 251. The power receiving coil 252 induces electricity and supplies the power to the holographic display assembly 24.

The holographic projection cooling fan 20 of the present invention can solve a power supply problem of the holographic display assembly 24 without excessively changing design of the driving assembly 22 or a common structure of the cooling fan.

Referring to FIG. 2, FIG. 3, and FIG. 4 again, in one embodiment, the frame 21 comprises a channel 211 and a mounting seat 212. The channel 211 passes through two opposite sides of the frame 21 to provide the fan blade 23 to be disposed of therein, and an airflow will be generated in the channel 211 when the fan blade 23 rotates. The mounting seat 212 is located in the channel 211, and the mounting seat 212 is provided with the driving assembly 22 and the power supply coil 251 to be mounted thereon. Further, the frame 21 is formed with at least one connecting rib 213 in the channel 211, and the connecting rib 213 is connected to the mounting seat 212, so that the mounting seat 212 is located at a center of the channel 211. In one embodiment, the frame 21 is formed with an annular groove 214 to provide the power supply coil 251 to be disposed of. On the other hand, the fan blade 23 includes a hub 231 and a plurality of blades 232. The hub 231 is provided for the power receiving coil 252 to be disposed of therein. Further, the power receiving coil 252 is located on a surface, facing the mounting seat 212, of the hub 231. The hub 231 is hat-shaped. In one embodiment, the hub 231 includes a base plate 233 and a plurality of annular walls 234. The base plate 233 is provided for the holographic display assembly 24 to be fixed thereon, and the base plate 233 is formed with at least one assembly structure 236 thereon for fixing the holographic display assembly 24. The at least one assembly structure 236 can be, for example, a hole or a convex column, which is not limited thereto. In addition, the base plate 233 is formed with at least one through hole 237 for two ends 253 of the power receiving coil 252 to be passed through and electrically connected to the holographic display assembly 24. On the other hand, the plurality of annular walls 234 are formed on one side of the base plate 233, the plurality of annular walls 234 are formed at intervals, a space 235 is formed between any two adjacent ones among the plurality of annular walls 234, and the power receiving coil 252 is disposed between any two adjacent ones among the plurality of annular walls 234, that is, the power receiving coil 252 is disposed in the space 235. When the plurality of annular walls 234 define a plurality of spaces 235, the plurality of spaces 235 that are not used for setting the power receiving coil 252 can be used for isolation to reduce influences of the driving assembly 22 on the power receiving coils 252. Further, the power receiving coil 252 is disposed at an outermost of the plurality of spaces 235.

The power receiving coil 252 is not limited to being flush with the ends of the plurality of annular walls 234. In one embodiment, the hub 231 further includes an isolation ring 238. The isolation ring 238 is assembled with an innermost ring of the plurality of annular walls 234 and faces the driving assembly 22, and the isolation ring 238 can be used as a protective shell of the driving assembly 22. In one embodiment, the hub 231 is formed with a plurality of support ribs 239. The support ribs 239 are disposed in the space 235 between any two adjacent ones among the plurality of annular walls 234 at intervals.

Referring to FIG. 2, FIG. 3 and FIG. 4 again, the driving assembly 22 of the present invention includes a circuit board 221 and a motor 222. The circuit board 221 forms a connection relationship with the motor 222. The circuit board 221 supplies power to the motor 222 through a circuit disposed on the circuit board, a power source of the circuit board 221 is an external power source, and the circuit board 221 receives external power supply through the power transmission line or the at least one conductive terminal. In the embodiment as shown in FIG. 2 of the present invention, the power supply coil 251 is connected to the circuit board 221, and the circuit board 221 supplies power to the power supply coil 251. In one embodiment, the power supply coil 251 and the circuit board 221 are independent structures, and the power supply coil 251 is located at a periphery of the circuit board 221. In other words, when viewed from the top of the mounting seat 212, the circuit board 221 is located inside, and the power supply coil 251 is located outside.

Referring to FIG. 2, FIG. 3 and FIG. 4 again, in one embodiment, the holographic display assembly 24 includes a lamp plate 241 and at least one cover plate 242. The lamp plate 241 is fixed on the fan blade 23. Specifically, the lamp plate 241 is fixed on the base plate 233 of the hub 231. On the other hand, the at least one cover plate 242 is disposed on the lamp plate 241, and a plurality of light emitting elements 243 on the lamp plate 241 is exposed by the at least one cover plate 242. In one embodiment, the cover plate 242 and the lamp plate 241 are both fixed on the fan blade 23 by a plurality of fixing pieces 244. On the other hand, the holographic display assembly 24 includes a wireless communication module 245 that establishes communication with an external component to receive at least one holographic display signal provided by the external component. The external component may be a component of a computer, a part of a controller, a wireless transmission module (not shown in the diagram) laid on the circuit board 221, or another circuit board disposed on the holographic projection cooling fan 20.

What is claimed is:

1. A holographic projection cooling fan, comprising:
a frame;
a driving assembly, disposed on the frame;
a fan blade, assembled with the driving assembly;
a holographic display assembly, fixed on the fan blade; and
a power conducting assembly, comprising a power supply coil disposed on the frame, and a power receiving coil disposed on the fan blade and directly facing the power supply coil, wherein the power receiving coil is connected to the holographic display assembly, the power supply coil obtains power from a transmissible power source on the holographic cooling fan, and the power receiving coil coordinates with the power supply coil to supply the power to the holographic display assembly.

2. The holographic projection cooling fan according to claim 1, wherein the frame comprises a channel, and a mounting seat located in the channel and provided for the driving assembly and the power supply coil to be mounted thereon, and the fan blade comprises a hub for setting the power receiving coil and a plurality of blades connected to the hub.

3. The holographic projection cooling fan according to claim 2, wherein the mounting seat is formed with an annular groove for setting the power supply coil.

4. The holographic projection cooling fan according to claim 2, wherein the hub comprises a base plate for fixing the holographic display assembly thereon and a plurality of annular walls formed at one side of the base plate at intervals, the power receiving coil is disposed between any two adjacent ones among the plurality of annular walls, the power receiving coil comprises two ends, and the base plate is formed with at least one through hole for the two ends passing through.

5. The holographic projection cooling fan according to claim 4, wherein the driving assembly comprises a circuit board, and a motor connected to the circuit board, and the circuit board receives external power.

6. The holographic projection cooling fan according to claim 5, wherein the power supply coil is located at a periphery of the circuit board.

7. The holographic projection cooling fan according to claim 4, wherein the hub comprises an isolation ring assembled with an innermost ring of the plurality of annular walls and facing the driving assembly.

8. The holographic projection cooling fan according to claim 1, wherein the holographic display assembly comprises a lamp plate fixed on the fan blade, and at least one cover plate disposed on the lamp plate.

9. The holographic projection cooling fan according to claim 8, wherein the cover plate and the lamp plate are both fixed on the fan blade.

10. The holographic projection cooling fan according to claim 1, wherein the holographic display assembly comprises a wireless communication module.

11. A holographic projection cooling fan, comprising:
a frame, adapted in an electronic device implemented with an ATX architecture;
a driving assembly, disposed on the frame;
a fan blade, assembled with the driving assembly;
a holographic display assembly, fixed on the fan blade; and
a power conducting assembly, comprising a power supply coil disposed on the frame, and a power receiving coil disposed on the fan blade and directly facing the power supply coil, wherein the power supply coil obtains power from a transmissible power source on the holographic cooling fan to establish a magnetic field, and the power receiving coil rotates with the fan blade and is located in the magnetic field to induce electricity and supply the power to the holographic display assembly.

12. The holographic projection cooling fan according to claim 11, wherein the frame comprises a channel, and a mounting seat located in the channel and provided for the driving assembly and the power supply coil to be mounted thereon, and the fan blade comprises a hub for setting the power receiving coil and a plurality of blades connected to the hub.

13. The holographic projection cooling fan according to claim 12, wherein the hub comprises a base plate for fixing the holographic display assembly thereon and a plurality of annular walls formed at one side of the base plate at intervals; the power receiving coil is disposed between any two adjacent ones among the annular walls, the power receiving coil comprises two ends, and the base plate is formed with at least one through hole for the two ends passing through.
